(19) United States
(12) Patent Application Publication
(10) Pub. No.: US 2026/0310581 A1
(43) Pub. Date: Oct. 8, 2026

(54) APPARATUS, METHOD AND COMPUTER PROGRAM FOR MONITORING PERFORMANCE OF SOFTWARE

(71) Applicant: Arm Limited, Cambridge (GB)

(72) Inventor: Michael John Williams, Cambridge (GB)

(73) Assignee: Arm Limited, Cambridge (GB)

(21) Appl. No.: 19/483,091

(22) PCT Filed: Feb. 1, 2024
(86) PCT No.: PCT/GB2024/050279

§ 371 Date: Nov. 10, 2025

(30) Foreign Application Priority Data
May 15, 2023 (GB) 2307176.4

(51) Int. Cl. G06F 11/3604

(52) U.S. Cl. CPC G06F 11/3612

(57) ABSTRACT

An apparatus has a plurality of event counters, each to maintain a respective count value based on monitoring of events occurring during execution of a sequence of instructions by processing circuitry. At least when a given condition is present, selection circuitry is responsive to a given instruction in the sequence whose execution by the processing circuitry will cause a number of operations to be performed that is dependent on associated instruction control information, where one or more of the operations are 2024/236258 associated with a given event being monitored by a given event counter, to apply a selection algorithm to derive a selected update indicator from the instruction control information. The selection algorithm is such that the selected update indicator varies over multiple applications of the selection algorithm. Count control circuitry is then arranged to cause the count value of the given event counter to be adjusted by a default amount to account for execution of the given instruction by the processing circuitry, when a value of the selected update indicator is a first value, or to cause the count value of the given event counter to be adjusted by a non-default amount to account for execution of the given instruction by the processing circuitry, when the value of the selected update indicator is a second value.

### BACKGROUND

The present technique relates to the field of data processing. More particularly, it relates to performance monitoring.

A data processing system may have performance monitoring circuitry for monitoring performance of software executing on processing circuitry. The performance monitoring circuitry includes event counters for counting occurrences of various events, such as the execution of an instruction, a miss in a cache or translation lookaside buffer, a buffer becoming full, instruction execution stalling, etc. The event count values maintained by the counters can be read by debug software and used for analysis of software performance to help identify possible reasons for any performance issues when the software is executing on the data processing system.

One or more of the event counters may be used to maintain a count that is related to the work done in response to execution of certain instructions, which may for example depend on the number of operations performed as a result of executing such instructions. However, in some instances it may be impractical and/or prohibitively expensive to seek to provide logic that can keep track of the exact number of operations performed, and cause the relevant event counter or event counters to be updated accordingly.

### SUMMARY

In one example arrangement, there is provided an apparatus comprising: a plurality of event counters each to maintain a respective count value based on monitoring of events occurring during execution of a sequence of instructions by processing circuitry; selection circuitry arranged, at least when a given condition is present, to be responsive to a given instruction in the sequence whose execution by the processing circuitry will cause a number of operations to be performed that is dependent on associated instruction control information, where one or more of the operations are associated with a given event being monitored by a given event counter, to apply a selection algorithm to derive a selected update indicator from the instruction control information, where the selection algorithm is such that the selected update indicator varies over multiple applications of the selection algorithm; count control circuitry arranged, at least when the given condition is present, to be responsive to the given instruction to: cause the count value of the given event counter to be adjusted by a default amount to account for execution of the given instruction by the processing circuitry, when a value of the selected update indicator is a first value; and cause the count value of the given event counter to be adjusted by a non-default amount to account for execution of the given instruction by the processing circuitry, when the value of the selected update indicator is a second value.

In another example arrangement, there is provided a computer-readable medium to store computer-readable code for fabrication of the apparatus mentioned above.

In a further example arrangement, there is provided a method for monitoring performance of software executing on processing circuitry, comprising: employing a plurality of event counters to maintain respective count values based on monitoring of events occurring during execution of a sequence of instructions of the software by the processing circuitry; at least when a given condition is present, being responsive to a given instruction in the sequence whose execution by the processing circuitry will cause a number of operations to be performed that is dependent on associated instruction control information, where one or more of the operations are associated with a given event being monitored by a given event counter:—to apply a selection algorithm to derive a selected update indicator from the instruction control information, where the selection algorithm is such that the selected update indicator varies over multiple applications of the selection algorithm;—to cause the count value of the given event counter to be adjusted by a default amount to account for execution of the given instruction by the processing circuitry, when a value of the selected update indicator is a first value; and —to cause the count value of the given event counter to be adjusted by a non-default amount to account for execution of the given instruction by the processing circuitry, when the value of the selected update indicator is a second value.

In a still further example arrangement, there is provided a computer program comprising instructions which, when executed by a host data processing apparatus, control the host data processing apparatus to provide an instruction execution environment for executing target program code, the computer program comprising: event counting program logic to emulate a plurality of event counters, each to maintain a respective count value based on monitoring of events occurring during simulated execution of a sequence of instructions of the target program code by processing program logic; selection program logic arranged, at least when a given condition is present, to be responsive to a given instruction in the sequence whose execution by the processing program logic will cause a number of operations to be performed that is dependent on associated instruction control information, where one or more of the operations are associated with a given event being monitored by a given event counter, to apply a selection algorithm to derive a selected update indicator from the instruction control information, where the selection algorithm is such that the selected update indicator varies over multiple applications of the selection algorithm; count control program logic arranged, at least when the given condition is present, to be responsive to the given instruction to: cause the count value of the given event counter to be adjusted by a default amount to account for execution of the given instruction by the processing program logic, when a value of the selected update indicator is a first value; and cause the count value of the given event counter to be adjusted by a non-default amount to account for execution of the given instruction by the processing program logic, when the value of the selected update indicator is a second value. Such a computer program can be disposed in any known transitory computer-readable medium (such as wired or wireless transmission of code over a network) or non-transitory computer-readable medium such as semiconductor, magnetic disk, or optical disc.

### BRIEF DESCRIPTION OF THE DRAWINGS

The present technique will be described further, by way of illustration only, with reference to examples thereof as illustrated in the accompanying drawings, in which:

FIG. 1 illustrates an example of a data processing system having performance monitoring circuitry;

FIG. 2 illustrates an example of performance monitoring circuitry;

FIG. 3 schematically illustrates how one or more counters may be updated in accordance with a first example implementation;

FIG. 4 schematically illustrates how one or more counters may be updated in accordance with a second example implementation;

FIG. 5 is a flow diagram illustrating how an event counter may be updated in accordance with one example implementation;

FIGS. 6A and 6B illustrate two examples of types of instruction that may result in a variable number of operations being performed;

FIGS. 7A and 7B illustrate two example arrangements that may be used by the count control circuitry in order to determine whether a given condition is present;

FIG. 8 is a flow diagram illustrating a merging process that may be performed in one example implementation; and

FIG. 9 illustrates a simulation example.

### DESCRIPTION OF EXAMPLES

In accordance with examples described herein, an apparatus is provided that has a plurality of event counters that are each used to maintain a respective count value based on monitoring of events occurring during execution of a sequence of instructions by processing circuitry. At least when a given condition is present, the apparatus takes a number of actions in response to a given instruction in the sequence whose execution by the processing circuitry will cause a number of operations to be performed that is dependent on associated instruction control information, where one or more of those operations may be associated with a given event being monitored by a given event counter. The actions taken are used to determine how to update that given event counter.

In particular, selection circuitry can be arranged to apply a selection algorithm to derive a selected update indicator from the instruction control information. The selection algorithm can take a variety of forms, but is such that the selected update indicator varies over multiple applications of the selection algorithm. Hence, over a period of time where the selection algorithm is applied multiple times, it is expected that the selected update indicator determined during one application of the selection algorithm will differ from the selected update indicator determined during another application of the selection algorithm. By way of example of suitable selection algorithms that may be used, a round robin algorithm may be used that cycles through a plurality of different possible portions of the instruction control information that can be selected as the update indicator, or a random or pseudo-random number generation algorithm may be used to randomly or pseudo-randomly determine a portion of the instruction control information to be selected as the update indicator. In other implementations, the selected update indicator may not correspond directly to a particular chosen portion of the instruction control information, but may be derived in some other manner from the instruction control information. For example, the instruction control information could take the form of a specified value that can take one of a plurality N of different possible values, and a random or pseudo-random generator could be used to generate a comparison value from amongst the N different possible values, with the value of the selected update indicator being set based on comparing the specified value with the comparison value. Purely by way of specific example, the selected update indicator could be set to a first value if the comparison value is the same or less than the value specified by the instruction control information, but otherwise could be set to a different, second, value.

Further, count control circuitry is arranged to be responsive to the given instruction to update the count value of the given event counter in dependence on the value of the selected update indicator. In particular, the count control circuitry is arranged to cause the count value of the given event counter to be adjusted by a default amount to account for execution of the given instruction by the processing circuitry, when a value of the selected update indicator is a first value. However, when a value of the selected update indicator is a second value, the count control circuitry instead causes the count value of the given event counter to be adjusted by a non-default amount to account for execution of the given instruction by the processing circuitry. It has been found that such a technique provides a statistical approach that enables a reliable count value to be maintained by the given event counter when taking into account a large enough sample of occurrences of events that cause the given event counter to be updated. In particular, such an approach avoids the likely over counting that would occur if the count value of the given event counter was updated by a fixed amount each time the given instruction is encountered (for example by an amount indicative of the maximum number of operations that could be performed), and hence can provide a much more reliable count value. Further, such an approach avoids the need to seek to provide logic to actively determine the number of operations performed each time the given instruction is executed, which in many situations would be prohibitively expensive (for example in terms of the cost and complexity of such additional logic, the power consumed by such logic, etc.).

The selection circuitry and the count control circuitry can be provided at a variety of locations within the apparatus. Merely by way of example, one or both of the selection circuitry and the count control circuitry could be provided within the processing circuitry, or could be provided within performance monitoring circuitry used to monitor the performance of software executing on the processing circuitry.

The non-default amount by which the count value is adjusted when the value of the selected update indicator is the second value can take a variety of forms. However, in one example implementation, the non-default amount is a zero amount, and as a result update of the count value of the given event counter is inhibited when the value of the selected update indicator is the second value, and hence no adjustment is made to account for execution of the given instruction by the processing circuitry in that instance. In such an application, the default amount by which the count value of the given event counter is adjusted when the value of the selected update indicator is the first value may also take a variety of forms. For example, that default amount may be chosen to be indicative of a maximum number of operations that could be performed, and hence based on the selected update indicator that is determined for any particular instance of the given instruction, the count value will either be updated by that default, maximum, amount, or will not be updated at all. It has been found that this can provide a particularly effective mechanism for maintaining a reliable count value when taking into account a large enough sample of occurrences of instructions that cause the given event counter to be updated and for which the number of operations performed on execution of any particular occurrence may vary.

It should also be noted that the number of bits contained within the selected update indicator can be varied dependent on implementation. For instance, in some example implementations more than one bit may form the selected update indicator, and hence there may be more than two possible values of the selected update indicator. In such instances, whilst one value of the selected update indicator may cause the count value to be updated by the default amount, and another value of the selected update indicator may cause the count value to be updated by a non-default amount (for example a zero amount as discussed above), one or more additional values of the selected update indicator may cause the count value to be updated by one or more different non-zero amounts to the above-mentioned default amount (e.g. by half of the default amount).

The given instruction can take a variety of forms, but in one example implementation is an instruction that defines at least one operation that is performed a number of times, where the number of times is dependent on the instruction control information, and each instance of the operation is arranged to operate on data elements identified for that instance.

The instruction control information can take a variety of forms, dependent on the form of the given instruction, but in one example implementation is information used by the processing circuitry to control how many operations are performed on execution of the instruction. By way of example, such instruction control information may be provided for certain types of scalar instruction, such as a load multiple or store multiple instruction, where the load operation or store operation is repeated multiple times for a number of different memory addresses/associated data values. Instruction control information for such an instruction can take the form of information used to identify the load operations or store operations to be performed (for example a field/mask value may encode which registers are to be accessed when executing the load multiple instruction or the store multiple instruction, and hence effectively identify how many load operations or store operations are to be performed). In accordance with the techniques described herein, a selected update indicator can be determined using the selection circuitry, and then the value of that update indicator determined in order to decide how to update the count value. As noted earlier, the way in which the selected update indicator is determined from such instruction control information may vary dependent on implementation. For example, the selected update indicator may take the form of a selected portion (e.g. bit) of the field/mask value. However, in an alternative embodiment, a specified value (e.g. a specified number of registers accessed when executing a load multiple or store multiple instruction) from amongst N different possible values (e.g. a total number of registers) may be set as the instruction control information, and the selected update indicator can be set based on a comparison of that specified value with a generated comparison value.

In another example, the processing circuitry may be arranged to perform vector processing in response to vector instructions, and one or more of those vector instructions may identify one or more predicate operands used to identify which data elements within one or more source vectors are to be subjected to the processing defined by the vector instruction. Hence, the number of operations performed in response to any particular instance of the instruction will be dependent on the form of the predicate operand(s). The predicate operand(s) can take a variety of forms. For instance, a predicate operand may identify predicate information in the form of a number (also referred to herein as a specified value) which can be used to identify which data elements of a vector to process, or alternatively the predicate information identified by a predicate operand may comprise a plurality of predicate bits, where each predicate bit is associated with a corresponding data element in a given source vector identified by the given instruction, and the value of each predicate bit is used to determine whether the corresponding data element should be subjected to the processing operation or not. Irrespective of how the predicate information is specified, then in accordance with the techniques described herein a selected update indicator can be determined by the selection circuitry from the predicate information, and the value of that selected update indicator then used in order to decide how to update the count value. For example, when the predicate information take the form of a plurality of predicate bits, one or more of those predicate bits may be selected to form the selected update indicator. Alternatively, where the predicate information takes the form of a specified value (e.g. a specified number of data elements of the given source vector) from amongst N different possible values (e.g. a total number of data elements in the given source vector), the selected update indicator can be set based on a comparison of that specified value with a generated comparison value.

The earlier-mentioned default amount can be specified in a variety of ways, but in one example implementation can be specified on an event-by-event basis. In one example implementation, the count control circuitry may be arranged to receive event indications generated by the processing circuitry during execution of the sequence of instructions, where the event indication associated with execution of the given instruction can be arranged to identify the given event and an indication of the default amount. The way in which any given event is identified to the count control circuitry can take a variety of forms. For example, an event identifier value may be provided as part of the event indication in one example implementation. However, in another example implementation, event indications associated with different events are input to the count control circuitry over different input connections, and hence the identification of the event is implicit from the input connection (e.g. wire or wires) that the event indication is received on.

The event indications can be generated at a variety of places within the processing circuitry. For example, the processing circuitry may be organised in a pipeline arrangement, and the event indications may be generated at a suitable pipeline stage. For instance, in one example implementation the event indications may be generated at the instruction decode stage, prior to the instructions being executed by the processing circuitry. This enables the event indications to be generated at a relatively early stage in the processing pipeline. However, it is possible that the associated determination of the selected update indicator, and evaluation of the value of that selected update indicator, may take place at a later stage than the decode stage. In such instances, the count control circuitry may be further arranged to receive the value of the selected update indicator for the given instruction in a manner that enables correlation with the event indication associated with execution of the given instruction. This can for instance be useful where the count control circuitry is provided externally to the processing circuitry, for example as part of a performance monitoring unit provided in association with the processing circuitry. There are various ways in which such correlation can be achieved. For example, where different events are signalled on different input connections (for example different groups of wires), the value of the selected update indicator can also be provided over the appropriate input connection for the event to which that information relates. In another example implementation, some other identifier (ID) information can be associated with both the event indication and the value of the selected update indicator, or issuance of the event indication to the count control circuitry can be deferred until the value of the selected update indicator has been determined, so as to allow all of the required pieces of information to be provided to the count control circuitry together.

It should also be noted that in some example implementations the value of the selected update indicator could be shared by multiple events, in order to influence how associated counters are updated in response to those multiple events.

In an alternative example configuration, the count control circuitry may incorporate the selection circuitry, and may be arranged to determine the selected update indicator and evaluate the value of the selected update indicator. Such an approach could for example be taken in implementations where the count control circuitry is provided as part of the processing circuitry. In such cases, the count control circuitry may hence be located separately to a performance monitoring unit that provides the various event counters, and in such cases an update control signal can be issued from the count control circuitry to the performance monitoring unit to identify how the various counters should be updated, in dependence upon event indications received by the count control circuitry. Indeed, in situations where it is determined that no update should be performed (for example in the earlier-discussed case where the non-default amount used when a value of the selected update indicator is a second value is in fact a zero amount), then the count control circuitry can merely be arranged to suppress generation of any update control signal to the performance monitoring unit in situations where it is determined that no counter update should be performed to account for execution of the given instruction.

As mentioned earlier, in some example implementations the above functionality of updating the count value of the given event counter by a default amount or a non-default amount may only be implemented in situations where the given condition is determined to be present. There are various ways in which the presence of the given condition may be determined. For instance, in one example implementation the apparatus may further comprise configuration storage which is referenced by the count control circuitry in order to determine whether the given condition is present.

The configuration storage can be organised in a variety of ways. For example, the configuration storage may provide a global condition indicator identifying whether the given condition is present or absent, which applies irrespective of which event is being considered by the count control circuitry. This can hence allow the above functionality to be turned on or off as required, as a global parameter affecting all relevant events (i.e. those events whose associated count value is updated in dependence of the number of operations performed when executing one or more instructions, where those operations are ones for which the technique described herein is used). In an alternative implementation, the configuration storage may provide a plurality of individual condition indicators, where each individual condition indicator is associated with one of the event counters and is arranged to identify whether the given condition is present or absent for the associated event counter. Hence, this allows a finer granularity in the setting of the given condition for one or more event counters. Whilst in one example a separate condition indicator could be provided for each relevant event counter, in an alternative implementation a condition indicator could be shared by multiple event counters, depending on the granularity with which it is desired to be able to specify the presence or absence of the given condition.

As an alternative to the use of configuration storage as discussed above, in an alternative implementation presence or absence of the given condition may be predetermined based on the event being considered by the count control circuitry. Hence, in such a scenario the presence or absence of the given condition is an implicit property of certain events rather than something that needs to be determined with reference to configuration storage. In some implementations, this may provide a low cost mechanism for implementing the above functionality, where it is known that the given condition should always be determined to be present for one or more events, and not present for certain other events.

As a yet further example implementation, the apparatus could adopt a fixed behaviour for every relevant event, and hence for example could always use the above described technique for such events without needing to evaluate whether the given condition is present or absent.

In one example implementation, the count control circuitry is arranged, in the absence of the given condition for the given event, to cause the count value of the given counter to be adjusted by the default amount to account for execution of the given instruction by the processing circuitry. Hence, in the absence of the given condition being detected, a standard update mechanism can be adopted.

There are a variety of ways in which the default amount may be determined. For example, in situations where vector processing is being performed, then in some implementations a fixed vector length may be used, and the default amount may be determined in dependence on the number of data elements within that vector length. For example, at the time of decoding an instruction, the data element size may be known, and hence the number of data elements within the fixed vector length can be determined, and that value can be used when determining the default amount by which the count value should be updated.

In other situations, the vector length may be configurable within the instruction set architecture, with any particular implementation having a chosen vector length amongst a number of different allowable vector lengths, but with the instructions themselves being organised so as to be vector length agnostic. Such an approach is adopted by the Arm Scalable Vector Extension (SVE) developed by Arm Limited, Cambridge, United Kingdom. In such implementations, the default amount may be determined, for example, in dependence on the number of data elements within a predetermined vector length. The predetermined vector length may hence be a fixed vector length, irrespective of the actual vector length chosen in any particular implementation (which would typically be a multiple of that fixed vector length). Since the count values will be updated by update amounts that are based on the predetermined vector length, the software being executed on any particular implementation can scale those count values as required, taking into account the actual vector length used in that particular implementation.

In addition to the number of data elements within a certain vector length influencing the default amount, or as an alternative thereto, the default amount may be determined in dependence on a number of operations forming the at least one operation defined by the given instruction. Certain instructions may require more than one operation to be performed in order to implement the processing required by that instruction. Merely by way of specific example, a multiply accumulate instruction may be considered to comprise two operations, i.e. a multiply operation and an accumulate operation.

In one specific example implementation, the default amount is chosen in dependence on both the number of operations defined by the given instruction, and the number of data elements within a predetermined vector length. Hence, purely by way of specific example, if the instruction defines two operations to be performed per data element, and the number of data elements in the predetermined vector length is determined to be 8, then the default amount may be chosen to be 16. It should be noted that for some events the default amount may be chosen taking into account only a subset of the operations defined by the given instruction. Purely by way of example, it may be determined for a certain event that only the number of multiplies should be counted, but not the number of adds, when executing multiply accumulate instructions.

In one example implementation, the count control circuitry may be arranged when multiple events are detected that are associated with the given event counter, at least when the given condition is present, to create merged update information for the given event counter based on the default amount for each of the multiple events and the value of the selected update indicator associated with each of the multiple events. This can be useful in a variety of situations, to reduce the number of updates required to counters, and/or to defer updating the counters until a certain condition is met. For example, if instructions are being speculatively executed, it may be possible using such an approach to hold back counter updates for such speculatively executed instructions until the commit point is reached, by maintaining merged update information that can then be used to update the counter once the commit point is reached. As another example, when performing superscalar processing, where multiple instructions are executed in parallel by different execution units within a processor, each instruction having different instruction control information, it may be possible to create merged update information that is then used to update the relevant event counter. Such merging may be implemented at a variety of locations within the system, for example within a processing unit, or within a unit shared amongst a number of processing units that are each being used to execute instructions.

Particular example implementations will now be discussed with reference to the accompanying figures.

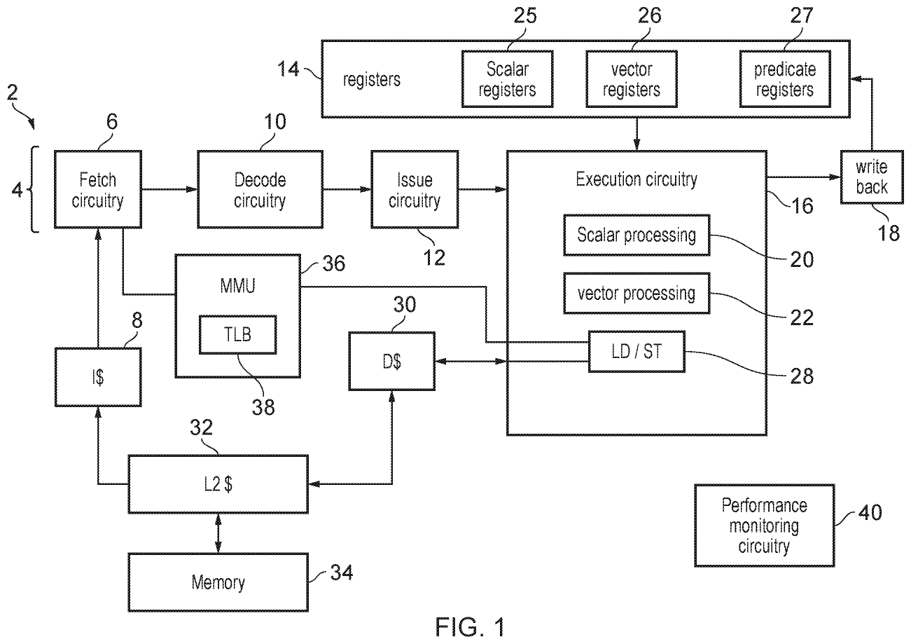

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline arrangement, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar processing unit 20 (e.g. comprising a scalar arithmetic/logic unit (ALU) 20 for performing arithmetic or logical operations on scalar operands read from the registers 14); a vector processing unit 22 for performing vector operations on vectors comprising multiple data elements; and a load/store unit 28 for performing load/store operations to access data in a memory system 8, 30, 32, 34. Other examples of processing units which could be provided at the execute stage could include a floating-point unit for performing operations involving values represented in floating-point format, or a branch unit for processing branch instructions.

The registers 14 include scalar registers 25 for storing scalar values, vector registers 26 for storing vector values, and predicate registers 27 for storing predicate values. The predicate values 27 may be used by the vector processing unit 22 when processing vector instructions, with a predicate value in a given predicate register indicating which data elements of a corresponding vector operand stored in the vector registers 26 are active data elements or inactive data elements (where operations corresponding to inactive data elements may be suppressed or may not affect a result value generated by the vector processing unit 22 in response to a vector instruction).

A memory management unit (MMU) 36 controls address translations between virtual addresses (specified by instruction fetches from the fetch circuitry 6 or load/store requests from the load/store unit 28) and physical addresses identifying locations in the memory system, based on address mappings defined in a page table structure stored in the memory system. The page table structure may also define memory attributes which may specify access permissions for accessing the corresponding pages of the address space, e.g. specifying whether regions of the address space are read only or readable/writable, specifying which privilege levels are allowed to access the region, and/or specifying other properties which govern how the corresponding region of the address space can be accessed. Entries from the page table structure may be cached in a translation lookaside buffer (TLB) 38 which is a cache maintained by the MMU 36 for caching page table entries or other information for speeding up access to page table entries from the page table structure shown in memory.

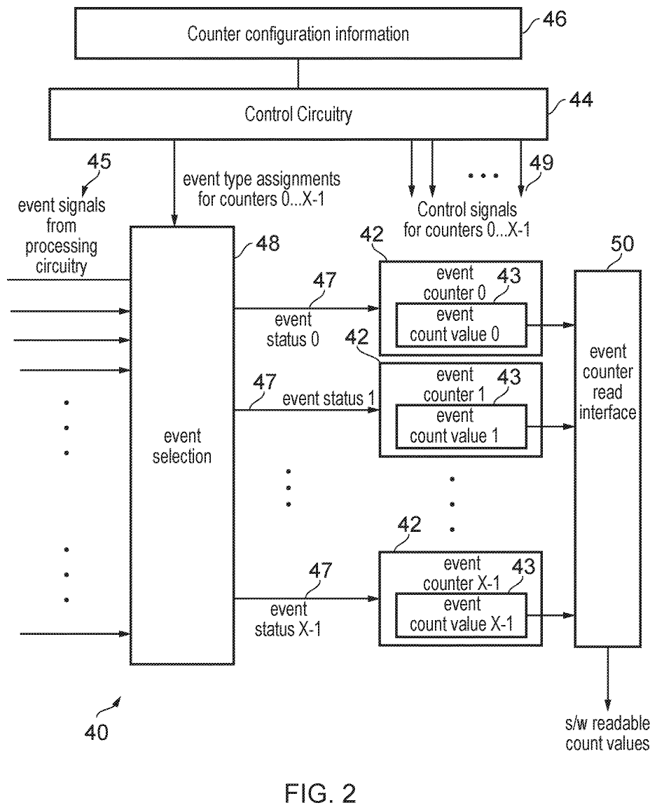

In this example, the memory system includes a level one data cache 30, a level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline arrangement, and the processor may include many other elements not illustrated for conciseness. The apparatus 2 also has performance monitoring circuitry 40 for monitoring performance of software executing on the processing circuitry 4. The performance monitoring circuitry 40 is shown in more detail in FIG. 2. As shown in FIG. 2, the performance monitoring circuitry 40 includes a number of event counters 42 which each maintain a corresponding event count value 43. The performance monitoring circuitry also includes control circuitry 44, which configures how the event counters behave, based on counter configuration information 46 set by a user. For example, the counter configuration information 46 could be state information stored in registers 14 of the processor (e.g. system registers), could be stored in memory-mapped registers implemented as distinct hardware separate from the memory system 30, 32, 34 or stored within the memory system 30, 32, 34 itself (in the case of memory-mapped registers or a data structure in memory itself being used to provide the counter configuration information, the control circuitry 44 may access those registers/structure based on a base address that is programmable by the user). Hence, in general a programming interface is provided to allow a user (e.g. a software developer performing debugging) to program the counter configuration information 46 so that the event counters 42 can be configured to gather various types of performance monitoring information of interest when debugging a particular program running on the processing circuitry 4. For example, debugging software may be executed to set the counter configuration information. The target program being debugged can then be executed. During execution of the target program, the performance monitoring circuitry 40 functions according to the previously set counter configuration information.

The performance monitoring circuitry 40 includes event selection circuitry 48 which receives from the processing circuitry 4 and other parts of the data processing system 2 a number of event signals 45 which indicate status of a corresponding type of event. Although shown as a single logic block in FIG. 2, the event selection circuitry may comprise a separate event selector for each event counter, which independently selects the event signal 45 to be monitored by the corresponding event counter.

For example, event signals could be generated to indicate a wide variety of types of information about various components of the data processing apparatus 2.

Some event signals may indicate the occurrence of a specific action (or a count of how many times that action has occurred). For example, such an action may include any of:
elapse of a clock cycle;
execution of an instruction (either any instruction in general, or an instruction of one or more specific types);
the number of operations performed by an instruction, or a value indicative thereof (either any operation in general, or an operation of one or more specific types);
a memory access request being made (either any memory access in general, or memory accesses of specific types, e.g. loads or stores);
a cache access, cache linefill or cache miss occurring (in some cases, this could be specific to a particular level or type of cache);
a TLB access, TLB linefill or TLB miss occurring (again, this could be events tracked for any TLB in general, or could be specific to particular TLB instances (e.g. data-side TLB or instruction-side TLB) or particular TLB levels (e.g. level 1 or level 2));
a branch misprediction occurring;
a queue or buffer becoming full (variants of which can be provided for specific buffers such as an instruction issue queue, load buffer, store buffer, etc.); or a stall of the pipeline occurring due to a particular cause (e.g. a cache miss, a TLB miss, or a load or store buffer becoming full).

Other event signals may specify quantitative information providing a quantitative status value indicating a property of an event that has occurred, such as:
a number of page table walk operations (requests to fill the TLB with a page table entry loaded from memory) in progress in a given cycle;
a number of cache linefill requests (requests to bring data into a cache following a cache miss) pending in a given cycle; or
an indication of current occupancy of a particular instance of a queue or buffer provided in hardware.

It will be appreciated that the lists of event types above are not exhaustive and that a wide variety of different event types could be monitored.

The counter configuration information 46 includes event type assignment information which specifies the event type to be monitored by each event counter 42. For example, each event counter 42 may have a corresponding event type field within the counter configuration information which has an encoding selecting which of the event signals 45 to use for a particular event counter 42. For each event counter, the event selection circuitry 48 selects, based on the event type assignment information for that counter, one of the event signals 45 which is passed to the corresponding event counter 42 as an event status indication 47 representing the status of the event assigned to that event counter 42 by the counter configuration information 46.

For each event counter 42, a set of hardware circuit logic is provided including storage circuitry for storing the corresponding event count value 43 and counter update logic circuitry (implemented in hardware) for updating the event count value as a function of the event status indication 47 provided to that counter 42 by the event selection circuitry 48. For example, an increment value may be selected as a function of the event status indication 47 and a new value of the event counter value 43 may be calculated by adding the increment value to the previous value of that event counter value 43. Control signals 49 may be provided to each event counter 42 by the control circuitry 44, based on the counter configuration information 46. These control signals 49 may configure how a given counter selects the function to be applied to the event status indication 47 and how the increment value is to be selected based on the result of applying the function to the event status indication 47.

The performance monitoring circuitry 40 provides an event counter read interface 50 which allows software to read the event count values for each counter 42. For example, the read interface 50 may be provided by exposing each event count value 43 to the software as system registers which can be read by system register read instructions executed by the processing circuitry 4. Alternatively, the event count values 43 of each event counter 42 may be exposed through a memory-mapped interface so that they can be read by the software executing load instructions specifying memory addresses mapped to the storage locations storing the respective event count values 43. Either way, debugging software can read the current values of each event count value to determine information about what has happened when target software was being processed by the processing circuitry. In use, for example, the debugging software may use breakpoints or watchpoints to trigger an exception when the target software has reached the desired point at which investigation is required (e.g. a desired instruction address reached in program flow, or a desired data address accessed by a memory access instruction), and then when the exception is triggered, an exception handler provided by the debugging software can read out the event count values 43 and analyze the information provided by each event count value 43 to determine what has happened. This can be useful for diagnosing potential performance inefficiencies in the program code, to help identify possible improvements that could be made to the program code being executed to allow it to run more efficiently.

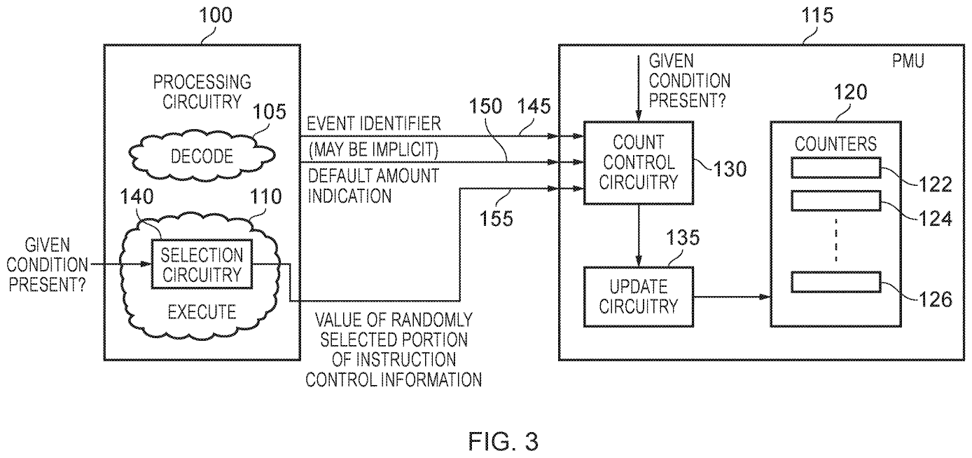

As discussed earlier, one or more of the event counters may be used to maintain a count value that is related to the work done in response to execution of certain instructions, which may for example depend on the number of operations performed as a result of executing such instructions. FIG. 3 schematically illustrates how such counters may be updated in accordance with a first example implementation. Processing circuitry 100 is provided for executing a sequence of instructions including instructions of the above type. The instructions are decoded by a decode stage 105 within a processing pipeline of the processing circuitry 100, and in due course may be executed in an execute stage 110 within the processing pipeline.

A performance monitoring unit 115 is provided, which may take the form of the performance monitoring circuitry 40 discussed earlier. Storage 120 is provided for maintaining a plurality of event counters 122, 124, 126, each of which can be used to maintain a respective count value based on monitoring of events occurring during execution of instructions by the processing circuitry 100. The event counters 122, 124, 126 hence correspond to the event counters 42 discussed earlier with reference to FIG. 2.

As discussed earlier with reference to FIG. 2, a set of hardware circuit logic can be provided for the various counters, and this may include the count control circuitry 130 and the update circuitry 135 shown in FIG. 3. Whilst in FIG. 3 each of the count control circuitry 130 and update circuitry 135 is shown as a single logic block, they may in an alternative implementation each comprise separate count control and update circuits for each event counter. During execution of instructions by the processing circuitry 100, event indications may be output to the PMU 115 identifying events which may require the update of one or more of the counters 122, 124, 126. For simplicity of discussion, in the following description reference will be made to the update of a singular counter, but it will be appreciated that certain events may cause more than one counter to be updated. The format of the event indications may vary dependent on the type of event being indicated, but considering events related to execution of instructions of the type discussed earlier, where execution of such instructions may cause a number of operations to be performed that is dependent on associated instruction control information, an event indication for such an instruction may in one example implementation be generated at the decode stage 105 when the instruction is decoded. The event indication may include an event identifier 145 and the default amount indication 150, the default amount indication indicating a default amount by which an associated counter within the counter storage 120 should be updated to take account of execution of the instruction. Whilst the event identifier 145 may be an explicit identifier value in one example implementation, in another example implementation event indications associated with different events are provided over different input connections to the PMU 115, and hence the identification of the event is implicit from the input connection (e.g. wire or wires) that the event indication is received on.

As discussed earlier, in accordance with the statistical approach adopted when using the present technique, whether the relevant counter is updated by the default amount, or by some other amount (for example a zero amount that hence inhibits an update of the relevant counter) is dependent on the value of a selected update indicator derived from the instruction control information, and that selected update indicator may in one example implementation be determined by the selection circuitry 140 shown in FIG. 3. This may be provided at a variety of locations within the system, but in the example shown in FIG. 3 is shown as being associated with the execute stage of the processing circuitry 100. In particular, the instruction control information will be made available to the execute stage 110, and hence will be available for analysis by the selection circuitry 140 at that stage.

The selection circuitry is arranged to apply a selection algorithm in order to determine the selected update indicator from the instruction control information. For the purposes of the following discussion, it will be assumed that the selection algorithm is arranged to determine a selected portion of the instruction control information to form the selected update indicator. However, in alternative implementations, the selected update indicator may be derived from the instruction control information in any suitable manner.

The selection algorithm can take a variety of forms, but is such that the selected portion that is determined varies over multiple applications of the selection algorithm. By way of example of suitable selection algorithms that may be used, a round robin algorithm may be used that cycles through a plurality of different possible portions that can be selected, or a random or pseudo-random number generation algorithm may be used to randomly or pseudo-randomly determine the portion of the instruction control information to be selected. In accordance with the approach shown in FIG. 3, it is assumed that a random or pseudo-random number algorithm is applied, and hence a randomly selected portion of the instruction control information is determined by the selection circuitry, and the value of that randomly selected portion is evaluated. That value can then be provided over path 155 to the count control circuitry 130 in a manner that enables it to be correlated with the event indication 145, 150.

There are various ways in which such correlation can be achieved. For example, where different events are signalled on different input connections (for example different groups of wires), the value of the randomly selected portion of the instruction control information can also be provided over the appropriate input connection for the event to which that information relates. In another example implementation, some other identifier (ID) information can be associated with both the event indication and the value of the selected portion of the instruction control information, or issuance of the event indication to the PMU 115 can be deferred until the value of the selected portion of the instruction control information has been determined, so as to allow all of the required pieces of information to be provided to the count control circuitry together.

The count control circuitry 130 is arranged to be responsive to the received event indication and associated value of the randomly selected portion of the instruction control information to cause the count value of the relevant event counter to be updated in dependence on the value of that selected portion of the instruction control information. In particular, the count control circuitry is arranged to cause the count value of the relevant event counter to be adjusted by a default amount to account for execution of the associated instruction by the processing circuitry, when a value of the selected portion of the instruction control information is a first value. However, when a value of the selected portion of the instruction control information is a second value, the count control circuitry instead causes the count value of the given event counter to be adjusted by a non-default amount (in one example implementation a zero amount) to account for execution of the associated instruction by the processing circuitry. Accordingly, based on the evaluation performed by the count control circuitry 130, a control signal can be sent to the update circuitry 135 to cause the appropriate counter to be updated as required.

The default amount by which the count value is adjusted when the value of the selected portion of the instruction control information is the first value may take a variety of forms. For example, that default amount may be chosen to be indicative of a maximum number of operations that could be performed on execution of the instruction that has given rise to the event indication, and hence based on the selected portion of the instruction control information the count value will either be updated by that default, maximum, amount, or may not be updated at all (in the case discussed earlier where the non-default amount is a zero amount). It has been found that this can provide a particularly effective mechanism for maintaining a reliable count value when taking into account a large enough sample of occurrences of instructions that cause an event counter to be updated and for which the number of operations performed on execution of any particular occurrence may vary.

In one example implementation, the above functionality of determining how one or more counters are updated in dependence on a randomly selected portion of instruction control information may be configurable. In particular, in one example implementation such functionality may only be implemented if a given condition is determined to be present, and otherwise a default update mechanism may be implemented, for example by updating the relevant counter by the default amount irrespective of the instruction control information. Various ways in which the presence or absence of the given condition can be determined will be discussed in more detail later.

The randomly selected portion determined by the selection circuitry 140 may comprise one or more bits of the instruction control information, as desired. If more than one bit is present in the randomly selected portion, then it will be appreciated that there will be more than two possible values of the randomly selected portion. In one example implementation, if more than two possible values are available, then multiple different update amounts may be determined based on the value of the randomly selected portion. For example, a first value may cause the relevant counter to be updated by the default amount, a second value may cause the counter not to be updated at all, and one or more other values may cause the relevant counter to be updated by other amounts different to the default amount (for example by half of the default amount). In one particular example embodiment, the processing circuitry is executing vector instructions, and the instruction control information takes the form of predicate information specified by a predicate operand of a vector instruction. Such predicate information can take a variety of forms, but in one particular example implementation comprises a plurality of predicate bits, where each predicate bit is associated with a corresponding data element in a given source vector identified by the instruction. In such cases, the selected portion of the instruction control information may in one example implementation take the form of a single one of those predicate bits, such that if that chosen predicate bit has a first value the relevant counter is updated by the default amount, whilst if the predicate bit has a second value the counter is not updated.

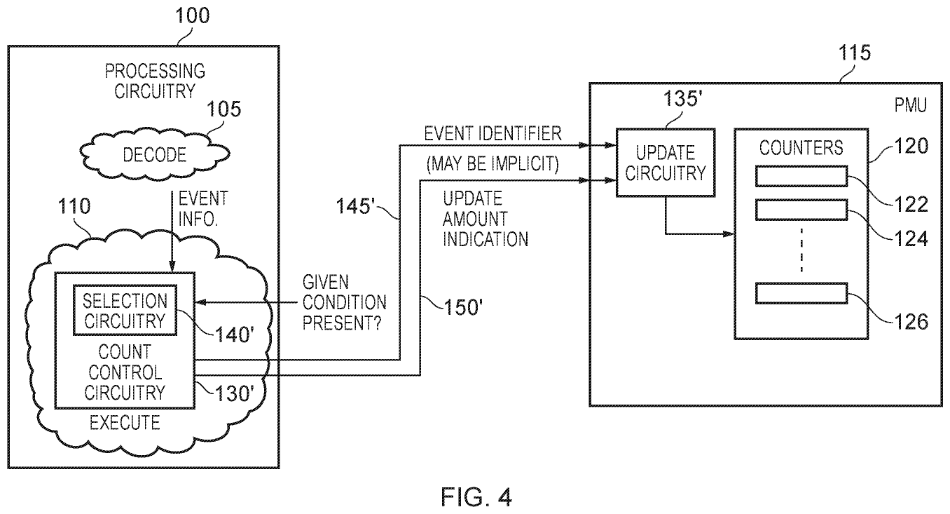

FIG. 4 schematically illustrates a variation of the technique shown in FIG. 3, where the count control circuitry 130′ is provided within the processing pipeline 100 and communicates over one or more event indication paths 145′, 150′ with update circuitry 135′ provided within the PMU 115. In such an implementation, the event information, such as may have been generated by the decode stage 105, is forwarded on to the count control circuitry 130′ for evaluation. The count control circuitry can be provided at a variety of locations within the processing pipeline, but in the example of FIG. 4 is considered to be associated with the execute stage 110. Furthermore, in this example the selection circuitry 140′ may be provided as part of the count control circuitry 130′.

Based on the selected portion of the instruction control information determined by the selection circuitry 140′, the count control circuitry 130′ can then determine whether the associated counter corresponding to the event information received should be updated by the indicated default amount (which may be provided as part of the event information), or updated by some other amount (for example a zero amount). Based on this determination, the count control circuitry can then issue an event indication to the update circuitry 135′ to identify the event (and hence the relevant event counter) and the update amount to be applied to that event counter, and the update circuitry can then apply that update accordingly. In one particular example implementation, the relevant event counter will either be updated by the default amount, or no update will be performed to the relevant event counter, dependent on the value of the selected portion of the instruction control information. In one example implementation, if the count control circuitry 130′ determines that no update should be performed, then no event indication needs to be issued to the PMU. Conversely, if an update is to be performed, then the update amount indication provided over path 150′ will be the default update amount provided in the event information analysed by the count control circuitry 130′.

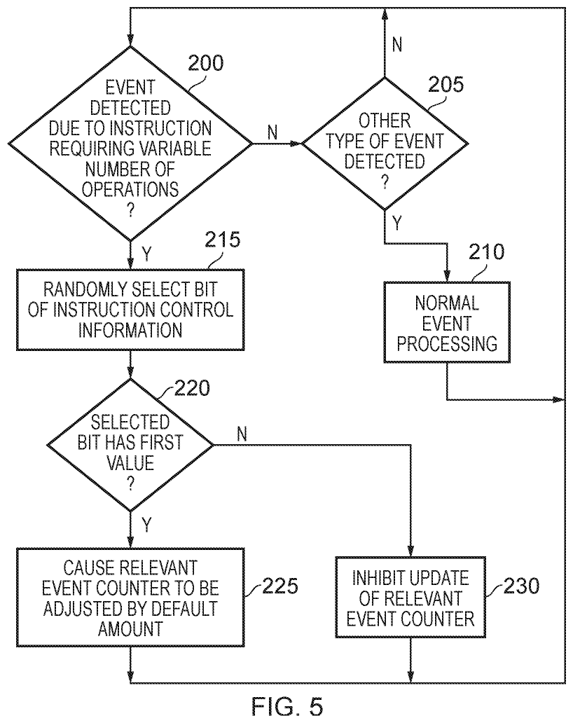

FIG. 5 is a flow diagram illustrating how an event counter may be updated in accordance with one example implementation. At step 200, it is determined whether an event has been detected due to encountering an instruction that requires a variable number of operations to be performed, dependent on instruction control information. If not, it is determined at step 205 whether any other type of event has been detected, and if so then at step 210 the other type of event is processed in the normal manner. Processing then returns to step 200 after performance of step 210, or directly to step 200 if no other type of event is detected at step 205.

When at step 200 an event is detected due to encountering an instruction that requires a variable number of operations to be performed, then at step 215 the earlier-described selection circuitry is employed to randomly select a bit of the instruction control information. It should be noted that if the event is of a type that requires multiple counters to be updated, then in one example implementation the same randomly selected bit of the instruction control information is used to control the update of each of those counters. It is then determined at step 220 whether that selected bit has a first value. If so, then at step 225 the relevant event counter associated with the event detected at step 200 is caused to be adjusted by the default amount. However, if the selected bit has a second value, then at step 230 an update of the relevant event counter is inhibited. Following either step 225 or step 230, the process then returns to step 200.

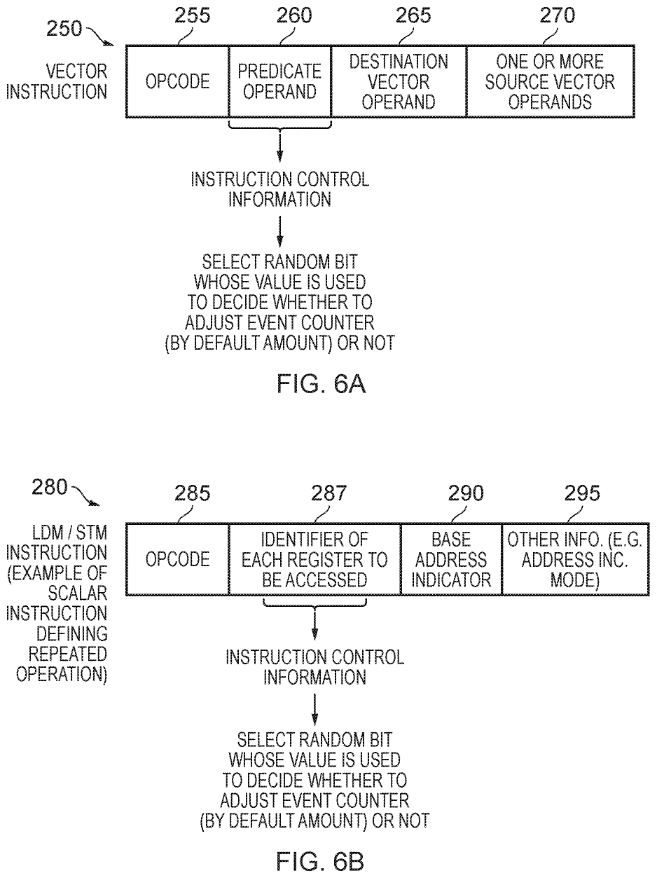

FIGS. 6A and 6B illustrate two examples of types of instruction that may result in a variable number of operations being performed, and hence for which the techniques described herein may be performed. FIG. 6A illustrates a vector instruction 250 having a plurality of fields. One field 255 is used to define the opcode, and hence defines the operation or operations that need to be performed in response to execution of that instruction. A source operand field 270 is used to identify one or more source vector operands, for example by identifying one or more vector registers 26 whose contents provide one or more source vectors, each comprising a plurality of data elements to which the defined operation(s) should be applied.

Further, a destination operand field 265 can be used to specify a destination vector operand, for example by identifying one of the vector registers 26 into which the results produced as a result of executing the instruction should be stored. In an alternative implementation, the destination operand may be one of the source operands, such that once the required computations have been performed to generate the results, those results are written back to one of the source vector operands to overwrite the previous contents. As shown in FIG. 6A, a predicate operand field 260 may also be provided identifying one or more predicate operands that form instruction control information. In one example, a predicate operand may take the form of a plurality of predicate bits, where each predicate bit is associated with one of the data elements in an associated source vector operand, with the value of a predicate bit identifying whether the associated data element should or should not be subjected to the operation(s) defined by the instruction. In one example implementation, the selection circuitry is used to select a random bit of the predicate information specified by a predicate operand, whose value is then used to decide whether to adjust the associated event counter (by the default amount) or not upon encountering the vector instruction in the sequence of instructions being executed by the processing circuitry.

In implementations where the data element size may vary, and hence the number of data elements within a certain vector length may vary, a predicate register used to define predicate information may have a number of bits sufficient to account for the smallest data element size, and the actual predicate bits used to form the predicate information in any particular instance will depend on the data element size in question.

However, the techniques described herein are not only applicable in relation to vector instructions. FIG. 6B illustrates an example of a scalar instruction that defines an operation that is performed a number of times, where that number of times is dependent on instruction control information. In particular, a load multiple or store multiple instruction 280 is illustrated, where the opcode field 285 will identify the operation to be performed, and hence can distinguish between a load multiple instruction and a store multiple instruction. A base address indicator field 290 can be used to identify a base address from which a first data value should be loaded, or to which a first data value should be stored, dependent on whether the instruction is a load multiple instruction or a store multiple instruction. One or more other fields 295 can also be used to specify other information relevant to execution of the instruction, for example to identify an address incrementing mode identifying how much the base address is adjusted by between each consecutive load or store operation. Further, a field 287 can be used to identify each of the registers to be accessed (and hence each of the registers into which a data value is to be loaded in the event of a load multiple instruction, or each of the registers from which a data value is to be stored to memory in the event of a store multiple instruction). This identifier information in the field 287 can take a variety of forms, but in one example may take the form of a mask that identifies which registers are to be accessed. This identifier information can hence be viewed as instruction control information, since it can be used to control the number of load (or store) operations that are performed. In one example implementation, a random bits of the information in the field 287 can be selected, and the value of that bit used to decide whether to adjust the relevant event counter (by the default amount) or not upon encountering the instruction in the sequence of instructions being executed by the processing circuitry. The default amount in this case may take a variety of forms, but could for example be indicative of the maximum number of registers that could be accessed by the load multiple or store multiple instruction, and hence the maximum number of load or store operations that would be performed on executing the instruction. In alternative implementations, the default amount may take into account other factors, such as the access size of the data being accessed (byte, word, etc), a predetermined vector length in an SVE implementation, etc.

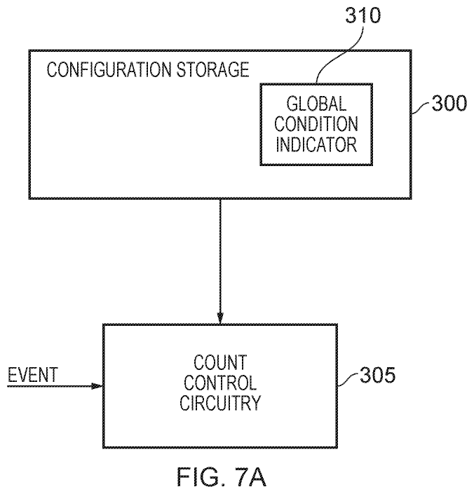

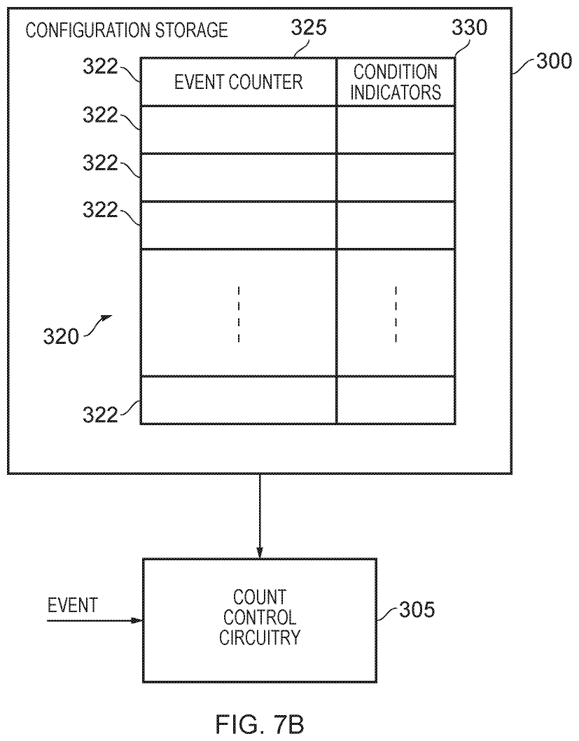

In implementations where application of the above described techniques is dependent on whether a given condition is determined to be present or not, then in one example implementation configuration storage can be used to store condition indicator information referenced to determine whether the given condition is present or not. FIG. 7A illustrates one such form of configuration storage 300, where a global condition indicator 310 is provided. The global condition indicator 310 as referenced by the count control circuitry 305 when considering a received event, in order to determine whether the given condition is present not. In one example implementation, this information may also be referenced by the selection circuitry 140. This approach can hence allow the above described functionality to be turned on or off as required, as a global parameter affecting all relevant events (i.e. those events whose associated count value is updated in dependence of the number of operations performed when executing one or more instructions).

In an alternative implementation as shown in FIG. 7B, the configuration storage 300 may provide a plurality of individual condition indicators, where each individual condition indicator is associated with one of the event counters and is arranged to identify whether the given condition is present or absent for the associated event counter. In particular, as shown in FIG. 7B, a table 320 may be maintained, having a plurality of entries 322. Each entry may be used to identify an event counter 325 and an associated condition indicator value 330 identifying when the given condition is to be considered present or absent for that event counter.

Hence, this allows a finer granularity in the setting of the given condition for one or more event counters. Whilst in one example a separate condition indicator could be provided for each relevant event counter, in an alternative implementation a condition indicator could be shared by multiple event counters, depending on the granularity with which it is desired to be able to specify the presence or absence of the given condition.

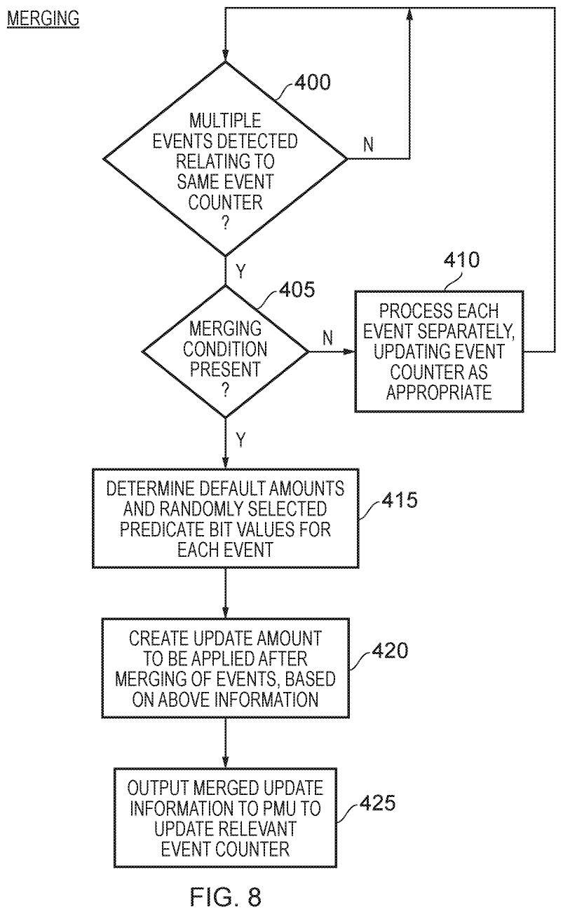

As illustrated with reference to the flow diagram of FIG. 8, in one example implementation the count control circuitry may be arranged, when multiple events are detected that are associated with a given event counter (due for example to multiple instructions each triggering the same event and hence each requiring updates to be made to the corresponding counter for that event), to create merged update information for the given event counter based on the default amount for each of the multiple events and the value of the selected portion of the instruction control information associated with each of the multiple events. As indicated at step 400, it is determined whether multiple events relating to the same event counter have been detected, and when such a situation is detected it is determined at step 405 whether a merging condition is present. The merging condition can take a variety of forms. For example, it could be decided to always merge events when multiple events are detected that relate to the same event counter. However, in alternative implementations the merging condition may only be determined to be present in certain situations, for example when speculatively executing instructions.

If the merging condition is not determined to be present, then at step 410 each event is processed separately, updating the event counter as appropriate, using the techniques discussed earlier, with the process then returning to step 400. However, assuming the merging condition is determined to be present at step 405, then at step 415 the default amounts associated with each of those events is determined, as is the value of the randomly selected predicate bits for each of those events. Then, at step 420, an update amount to be applied after merging is created, this update amount being based on the default amounts and randomly selected predicate bit values determined at step 415. There are various ways in which the update amount to be applied after merging may be created from the constituent information determined at step 415. However, purely by way of illustrative example, if an event is detected for each of instructions A, B and C at step 400, with the event associated with instruction A having a default amount of 4, the event associated with instruction B having a default amount of 4, and the event associated with instruction C having a default amount of 8, and if the randomly selected predicate bits for those three events are, 1, 0, 1, respectively (where a value of 1 indicates that the default amount should be applied, and a value of 0 indicates that no update should be applied), then the update amount created at step 420 may be an update amount of 12 in this particular example.

At step 425, the merged update information is then output in order to cause the relevant event counter to be updated. In the example of FIG. 8, it is assumed that the merging process is performed within the processing circuitry, or some other element external to the PMU, and hence the merged update information is output to the PMU. However, in an alternative implementation, the merging process may be performed by circuitry within the PMU.

In one example implementation, after the update amount has been created at step 420, the output of the merged update information may be deferred until some trigger event occurs. The trigger event could take a variety of forms, but as an example the trigger event may be the reaching of a commit point in relation to a speculative execution path containing the instructions that have given rise to the multiple events detected at step 400, so that the actual update of the relevant counter only occurs after the commit point has been reached.

The above described merging technique can be useful in a variety of situations, to reduce the number of updates required to counters, and/or to defer updating the counters until a certain condition is met. For example, if instructions are being speculatively executed, it may be possible as discussed above to hold back counter updates for such speculatively executed instructions until the commit point is reached, by maintaining merged update information that can then be used to update the counter once the commit point is reached. As another example, when performing superscalar processing, where multiple instructions are executed in parallel by different execution units within a processor, each instruction having different instruction control information, it may be possible to create merged update information that is then used to update the relevant event counter.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

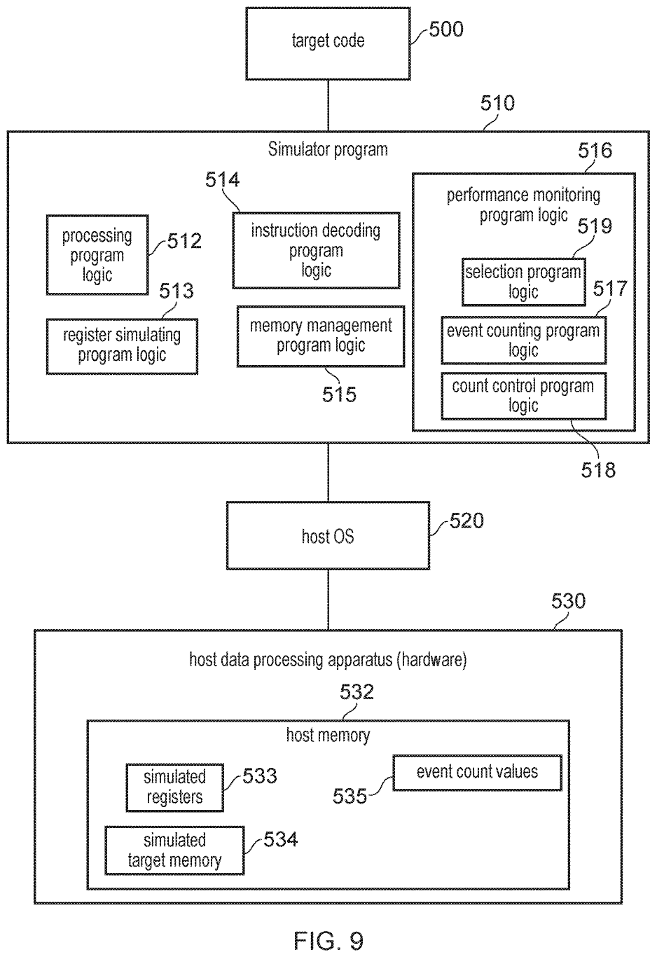

Also, FIG. 9 illustrates a simulator implementation that may be used. Whilst the earlier described embodiments implement the present invention in terms of apparatus and methods for operating specific hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 530, optionally running a host operating system 520, supporting the simulator program 510. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described examples are present on the host hardware (for example, host processor 530), some simulated embodiments may make use of the host hardware, where suitable.

The simulator program 510 may be stored on a computer-readable storage medium (which may be a non-transitory medium), and provides a program interface (instruction execution environment) to the target program code 500 (which may include applications, operating systems and a hypervisor) which is the same as the interface of the hardware architecture being modelled by the simulator program 510. Thus, the program instructions of the target code 500, including instructions of the type described earlier whose execution will cause a number of operations to be performed that is dependent on associated instruction control information, may be executed from within the instruction execution environment using the simulator program 510, so that a host computer 530 which does not actually have the hardware features of the apparatus 2 discussed above can emulate these features. The functions of the performance monitoring circuitry 40 can be emulated by corresponding program logic. By providing a simulation of the apparatus shown in FIG. 1 in a software form, this can allow debugging software for interacting with the performance monitoring circuitry 40 to be developed before the hardware is actually available.

Hence, the simulator program 510 may have processing program logic 512 which simulates the state of the processing circuitry 4 described above. Instruction decoding program logic 514 decodes instructions of the target code 500 and maps these to corresponding sets of instructions in the native instruction set of the host apparatus 530. The register simulating program logic 513 maps register accesses requested by the target code to accesses to corresponding register-emulating data structures 533 maintained by the host hardware of the host apparatus 530, such as by accessing data in registers or memory 532 of the host apparatus 530. Memory management program logic 515 implements address translation, page table walks and access control checking in a corresponding way to the MMU 36 described in the hardware-implemented embodiment above, but also has the additional function of mapping simulated physical addresses obtained by the simulated MMU 36 to host virtual addresses used to access host memory 532. These host virtual addresses may themselves be translated into host physical addresses using the standard address translation mechanisms supported by the host (the translation of host virtual addresses to host physical addresses being outside the scope of what is controlled by the simulator program 510). Hence, the simulated physical address space accessed by the target code 500 can be mapped to a region 534 of host memory 532 representing the simulated target memory 30, 32, 34 of the target processing apparatus 2 being simulated by the simulation program 510.

The simulator program 510 has performance monitoring program logic 516 which simulates the behaviour of the performance monitoring circuitry 40, and may include event counting program logic 517 which maintains event count values 535 in host memory 532 that correspond to the count values maintained within the event counters 42 of the hardware embodiment. Also, the performance monitoring program logic 516 includes count control program logic 518 which implements the functionality of the count control circuitry 130, 130′ of the hardware embodiment discussed earlier in order to cause the updates made to one or more count values to be dependent on the selected portion of instruction control information, and selection program logic 519 which implements the function of the selection circuitry 140, 140′ of the hardware embodiment to determine the selected portion of the instruction control information.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
a plurality of event counters each to maintain a respective count value based on monitoring of events occurring during execution of a sequence of instructions by processing circuitry;
selection circuitry arranged, at least when a given condition is present, to be responsive to a given instruction in the sequence whose execution by the processing circuitry will cause a number of operations to be performed that is dependent on associated instruction control information, where one or more of the operations are associated with a given event being monitored by a given event counter, to apply a selection algorithm to derive a selected update indicator from the instruction control information, where the selection algorithm is such that the selected update indicator varies over multiple applications of the selection algorithm;
count control circuitry arranged, at least when the given condition is present, to be responsive to the given instruction to:
cause the count value of the given event counter to be adjusted by a default amount to account for execution of the given instruction by the processing circuitry, when a value of the selected update indicator is a first value; and
cause the count value of the given event counter to be adjusted by a non-default amount to account for execution of the given instruction by the processing circuitry, when the value of the selected update indicator is a second value.

2. An apparatus as claimed in claim 1, wherein the non-default amount is a zero amount, so as to inhibit update of the count value of the given event counter to account for execution of the given instruction by the processing circuitry, when the value of the selected update indicator is the second value.

3. An apparatus as claimed in claim 1, wherein:
the given instruction is an instruction that defines at least one operation that is performed a number of times, where the number of times is dependent on the instruction control information, and each instance of the operation is arranged to operate on data elements identified for that instance.

4. An apparatus as claimed in claim 3, wherein:
the given instruction is a vector instruction identifying at least one source vector comprising a plurality of data elements, and the instruction control information comprises predicate information identifying which data elements in the at least one source vector are to be subjected to the at least one operation defined by the given instruction.

5. An apparatus as claimed in claim 4, wherein the predicate information comprises a plurality of predicate bits, where each predicate bit is associated with a corresponding data element in a given source vector identified by the given instruction, and the selected update indicator is one of the predicate bits.

6. An apparatus as claimed in claim 4, wherein the predicate information comprises a specified value used to identify which data elements in a given source vector are to be subjected to the at least one operation defined by the given instruction.

7. An apparatus as claimed in claim 1, wherein:
the count control circuitry is arranged to receive event indications generated by the processing circuitry during execution of the sequence of instructions, where the event indication associated with execution of the given instruction identifies the given event and an indication of the default amount.

8. An apparatus as claimed in claim 7, wherein:
the count control circuitry is further arranged to receive the value of the selected update indicator for the given instruction in a manner that enables correlation with the event indication associated with execution of the given instruction.

9. An apparatus as claimed in claim 7, wherein the count control circuitry incorporates the selection circuitry and is arranged to determine the selected update indicator and evaluate the value of the selected update indicator.

10. An apparatus as claimed in claim 1, further comprising:
configuration storage referenced by the count control circuitry to determine whether the given condition is present.

11. An apparatus as claimed in claim 10, wherein the configuration storage provides a global condition indicator identifying whether the given condition is present or absent, which applies irrespective of which event is being considered by the count control circuitry.

12. An apparatus as claimed in claim 10, wherein the configuration storage provides a plurality of individual condition indicators, where each individual condition indicator is associated with one of the event counters and arranged to identify whether the given condition is present or absent for the associated event counter.

13. An apparatus as claimed in claim 1, wherein presence or absence of the given condition is predetermined based on the event being considered by the count control circuitry.

14. An apparatus as claimed in claim 1, wherein the count control circuitry is arranged, in the absence of the given condition for the given event, to cause the count value of the given counter to be adjusted by the default amount to account for execution of the given instruction by the processing circuitry.

15. An apparatus as claimed in claim 1 when dependent on claim 4, wherein the default amount is determined in dependence on the number of data elements within a predetermined vector length.

16. An apparatus as claimed in claim 1 when dependent on claim 3, wherein the default amount is determined in dependence on a number of operations forming the at least one operation defined by the given instruction.

17. An apparatus as claimed in claim 1, wherein the count control circuitry is arranged when multiple events are detected that are associated with the given event counter, at least when the given condition is present, to create merged update information for the given event counter based on the default amount for each of the multiple events and the value of the selected update indicator associated with each of the multiple events.

18. (canceled)

19. A non-transitory computer-readable medium storing computer-readable code for fabrication of an apparatus according to claim 1.

20. A method for monitoring performance of software executing on processing circuitry, comprising:
employing a plurality of event counters to maintain respective count values based on monitoring of events occurring during execution of a sequence of instructions of the software by the processing circuitry;
at least when a given condition is present, being responsive to a given instruction in the sequence whose execution by the processing circuitry will cause a number of operations to be performed that is dependent on associated instruction control information, where one or more of the operations are associated with a given event being monitored by a given event counter:
to apply a selection algorithm to derive a selected update indicator from the instruction control information, where the selection algorithm is such that the selected update indicator varies over multiple applications of the selection algorithm;
to cause the count value of the given event counter to be adjusted by a default amount to account for execution of the given instruction by the processing circuitry, when a value of the selected update indicator is a first value; and
to cause the count value of the given event counter to be adjusted by a non-default amount to account for execution of the given instruction by the processing circuitry, when the value of the selected update indicator is a second value.

21. A non-transitory computer-readable storage medium storing a computer program comprising instructions which, when executed by a host data processing apparatus, control the host data processing apparatus to provide an instruction execution environment for executing target program code, the computer program comprising:
event counting program logic to emulate a plurality of event counters, each to maintain a respective count value based on monitoring of events occurring during simulated execution of a sequence of instructions of the target program code by processing program logic;
selection program logic arranged, at least when a given condition is present, to be responsive to a given instruction in the sequence whose execution by the processing program logic will cause a number of operations to be performed that is dependent on associated instruction control information, where one or more of the operations are associated with a given event being monitored by a given event counter, to apply a selection algorithm to derive a selected update indicator from the instruction control information, where the selection algorithm is such that the selected update indicator varies over multiple applications of the selection algorithm;
count control program logic arranged, at least when the given condition is present, to be responsive to the given instruction to:
cause the count value of the given event counter to be adjusted by a default amount to account for execution of the given instruction by the processing program logic, when a value of the selected update indicator is a first value; and
cause the count value of the given event counter to be adjusted by a non-default amount to account for execution of the given instruction by the processing program logic, when the value of the selected update indicator is a second value.
